(19) United States
(12) Patent Application Publication
(10) Pub. No.: US 2024/0301112 A1
(43) Pub. Date: Sep. 12, 2024

(54) FIBERS AND FABRICS WITH NITROGEN-CONTAINING ADDITIVES

(71) Applicant: Ascend Performance Materials Operations LLC, Houston, TX (US)

(72) Inventors: Wai-shing Yung, Houston, TX (US); Vikram Gopal, Houston, TX (US)

(73) Assignee: Ascend Performance Materials Operations LLC, Houston, TX (US)

(21) Appl. No.: 18/597,016

(22) Filed: Mar. 6, 2024

Related U.S. Application Data
(60) Provisional application No. 63/488,966, filed on Mar. 7, 2023.

(51) Int. Cl. C08F 283/04; C08K 3/105

(52) U.S. Cl. CPC C08F 283/04; C08K 3/105

(57) ABSTRACT

This disclosure relates to a process for making flame retardant fibers comprising the steps of combining a flame retardant masterbatch with a polymer to form a polymer composition and forming the flame retardant fibers from the polymer composition. The masterbatch comprises greater than 10 wt % of a nitrogen compound having a melting point less than 400° C.; and a masterbatch polymer, with the weight percentages based on the total weight of the masterbatch. The flame retardant fibers pass the flame retardancy standards of ASTM D6413 (current year).

### CROSS-REFERENCE TO RELATED APPLICATION

This application relates to and claims priority to U.S. Provisional Application No. 63/488,966, filed Mar. 7, 2023, the disclosure of which in incorporated herein by reference in its entirety.

### FIELD

The present disclosure relates to fibers or a fiber matrix or layer having improved flame retardancy performance and processability.

### BACKGROUND

Fibers or fabrics having some degree of flame retardancy are known. In some cases, spunbond polymer fabrics, either alone or as one of multiple layers, are employed in these garments.

Polymer compositions used to make fabrics/fibers are well known. U.S. Pat. No. 5,616,408 B2 discloses a nonwoven web of meltblown microfibers formed of a composition of polyethylene and at least one component added to provide processing stability to the polyethylene component. The meltblown web can be produced at high polymer throughputs and exhibits good barrier properties. The meltblown web is useful as a component of a composite fabric, which can be used for barrier application in medical and industrial applications.

As another example, U.S. Pat. No. 7,449,508 discloses a flame retardant and stabilizer combined for thermoplastic polymers, which comprises, as component A, from 20 to 80% by weight of a phosphinic salt and/or of a diphosphinic salt and/or polymers of these,

In addition, U.S. Pat. No. 11,104,799 discloses meltable flame retardant compositions and fibers fabricated thereof. The compositions comprise a polymer, a nitrogenous compounds and/or a phosphorus compound. The fibers and compositions can be used to make fabrics. When fibers, fabrics, and compositions of the present disclosure are exposed to flame, non-flammable gases are released such that the flames is retarded and/or extinguished.

Even in view of these references, the need exists for improved flame retardant fibers/fabrics that demonstrate improved flame retardancy and/or melt drip performance and that have improved processability.

### SUMMARY

In some cases, the present disclosure relates a process for making flame retardant fibers comprising: combining with a polymer, e.g., a polyamide, a flame retardant masterbatch comprising (less than 90 wt % of) a nitrogen compound, e.g., melamine or a melamine-based compound, having a melting point less than 400° C.; and (comprising greater than 10 wt % of) a masterbatch polymer to form a polymer composition optionally comprising an AM/AV compound, and forming the flame retardant fibers (optionally multicomponent fibers) from the polymer composition, wherein the flame retardant fibers pass the flame retardancy standards of ASTM D6413 (current year) and/or antiodor performance and/or antistatic performance. The flame retardant fibers may have an average fiber diameter less than 25 microns. The polymer composition may have an RV less than 90 as measured via the formic acid method. The forming may comprise forming first fibers comprising a first polymer, e.g., a polyamide, and a first flame retardant masterbatch and combining the first fibers with second fibers, e.g., second fibers comprising cotton. The disclosure also relates to a garment or uniform having antiodor properties and flame retardancy properties comprising fibers made from the process or to a garment or uniform having antistatic properties and flame retardancy properties comprising fibers made from the process.

### DETAILED DESCRIPTION

### Introduction

As discussed above, it is known to make fibers and fabrics from conventional polymer compositions. And some polymer compositions include flame retardants that provide some degree of flame retardancy performance. Many of these compositions are difficult to process, perhaps due to the incompatibility of the flame retardants with the polymer, e.g., during a fiber-spinning process. Further, conventional flame retardants leave some room for improvement, especially under specific operating conditions.

It has now been discovered that the use of specific flame retardants, e.g., nitrogen compounds, with particular polymers (as disclosed herein) provide for improved flame retardancy. In some cases, the flame retardant may advantageously be provided as a (component of a) masterbatch, which provides processing advantages over conventional uses where the flame retardant is combined directly with the polymer. In particular, the use of the masterbatch improves incorporation into and combination with the polymer and allows for higher loading levels to be achieved (versus direct, non-masterbatch combination), which contributes to the aforementioned performance improvements.

It has also been found that that the addition of an AM/AV compound to the aforementioned polymer compositions provides for fibers/fabrics having a synergistic combination of flame retardancy and antiodor properties. Such fabrics are well-suited for applications that require this combination, e.g., military uniforms or outdoor apparel, e.g., hunting clothes, or other apparel applications where the masking of scent is required. In addition, these AM/AV compounds have been found to contribute to superior washfastness, which may be measured via NFPA 2112 wherein a fabric is tested before and after 50 washes per ASTM 6413 and in both cases (the performance needs to meet the washfastness requirements both before and after). In some cases, washfastness may be reflected in flame retardant retention or AM/AV compound retention in the respective fabric (before and after a predetermined number of washes), see ASTM D6413 and/or NFPA 2112. In some cases, the fibers/fabrics may be made from AM/AV polymer compositions (comprising AM/AV compounds), and as such, will have AM/AV properties and/or antiodor properties. The aforementioned flame retardants may, in some cases, be employed with the AM/AV polymer compositions to yield fibers, filaments, fabrics, etc. AM/AV polymer compositions (with the AM/AV compounds) and fibers, filaments, yarns, matrices, and fabrics made therefrom are described, for example in U.S. Pat. Nos. 11,185,071; 11,505,701; and 10,662,561, along with U.S. patent application Ser. Nos. 17/192,491; 17/192,513; and Ser. No. 17/192,533 (and all of their respective progenies), all of which are incorporated by reference herein. The nitrogen compound may be employed in the AM/AV polymer compositions.

Still further, it has been discovered that the aforementioned flame retardants, when employed with polymer compositions and processes for making antistatic fibers, yield fibers/fabrics having a synergistic combination of antistatic (anti-spark) performance that is advantageously enhanced by the flame retardants and vice versa. The aforementioned flame retardants may, in some cases, be employed with these polymer compositions and used in disclosed processed to yield fibers, filaments, fabrics, etc. Such fabrics are well-suited for garments worn in anti-spark or anti-flame environments, e.g., coal mining uniforms or other apparel applications where the prevention of ignition sources is required. In some cases, the fibers/fabrics may be formed via the processes disclosed in US Patent Publication No. 2017/0314168 and WO2017176604A1 (and all of their progenies), all of which are incorporated by reference herein. The nitrogen compound may be employed in the polymer compositions disclosed therein and may be processed as disclosed therein.

The disclosure relates to a process for making flame retardant fibers. The process comprises the step of combining with a polymer a flame retardant masterbatch to form a polymer composition. The masterbatch comprises specific nitrogen compounds, e.g., nitrogen compounds having a melting point less than 400° C., along with a masterbatch polymer. While some masterbatch-related techniques are known, the provision of the specific nitrogen compounds in this manner allows for both processing advantages and improved flame retardancy performance of the fibers or the fabrics that may be formed therefrom. The process further comprises the step of forming the flame retardant fibers from the polymer composition. The performance of the resultant flame retardant fibers can be measured via ASTM D6413/D6413M-22, the purpose of which is to determine whether a fabric will continue to burn after the ignition source is removed.

The masterbatch comprises a concentrated mixture of flame retardant and masterbatch polymer. In some cases, the flame retardant masterbatch comprises greater than 10 wt % flame retardant, e.g., nitrogen compound, based on the total weight of the masterbatch, along with the masterbatch polymer. As noted above, the use of the disclosed masterbatch provides for higher loading levels, previously not achieved. It is postulated that the masterbatch provides improved incorporation into the polymer, which in turn allows for more flame retardant to be disposed within the structure thereof.

In some cases, the flame retardant may comprise a nitrogen compound, e.g., a nitrogen compound having a melting point less than 400° C. Such nitrogen compounds have been found to incorporate particularly well into the polymer when employed via a masterbatch. More details of the nitrogen compounds are disclosed herein.

In some embodiment, the fibers may comprise multiple types of fibers, e.g., first fibers and second fibers. The process may comprise the step of combining the first fibers with the second fibers to form a collection of fibers or a matrix of fibers or a fabric.

In some embodiments, the process forms a filament.

The fiber formation step may vary widely. In some cases the fibers may be formed via meltblown, electrospun, spunlace, needlepunch, and/or spunbond techniques. Additional formation methods are disclosed below.

In some embodiments, the fiber matrix is formed via melt spinning or melt blowing. In some embodiments, the fiber matrix is formed via solution spinning. In some embodiments, the fiber matrix is formed via spunbonding. Conventional methods of preparing a fiber matrix may be employed to form nonwoven products. Exemplary methods are disclosed in U.S. Pat. No. 10,662,561, which is incorporated herein by reference.

### Masterbatch

The masterbatch comprises a concentrated mixture of flame retardant, e.g., nitrogen compound, and masterbatch polymer. In some cases, the flame retardant masterbatch comprises greater than 10 wt % flame retardant, e.g., nitrogen compound, based on the total weight of the masterbatch, e.g., greater than 20 wt %, greater than 30 wt %, greater than 40 wt %, greater than 50 wt %, greater than 60 wt %, greater than 70 wt %, greater than 80 wt %, or greater than 90 wt %. In terms of upper limits, the flame retardant masterbatch may comprise less than 90 wt % flame retardant, based on the total weight of the masterbatch, e.g., less than 80 wt %, less than 70 wt %, less than 60 wt %, less than 50 wt %, less than 40 wt %, less than 30 wt %, less than 20 wt %, or less than 10 wt %.

In some cases, the flame retardant masterbatch comprises greater than 10 wt % masterbatch polymer, based on the total weight of the masterbatch, e.g., greater than 20 wt %, greater than 30 wt %, greater than 40 wt %, greater than 50 wt %, greater than 60 wt %, greater than 70 wt %, greater than 80 wt %, or greater than 90 wt %. In terms of upper limits, the flame retardant masterbatch may comprise less than 90 wt % masterbatch polymer, based on the total weight of the masterbatch, e.g., less than 80 wt %, less than 70 wt %, less than 60 wt %, less than 50 wt %, less than 40 wt %, less than 30 wt %, less than 20 wt %, or less than 10 wt %.

The masterbatch polymer may be one or more of the polymers disclosed below. The masterbatch polymer may be the same as the polymer used to form the fibers. In some cases, the masterbatch polymer may be different from the polymer used to form the fibers.

### Nitrogen Compounds

The chemistry and structure of the nitrogen compounds may vary widely.

In some cases, the nitrogen compound may be defined as an organic or inorganic molecule that contains nitrogen. The nitrogen compound may comprise triazine and/or triazine derivatives. For example, the nitrogen compound may comprise 1,3,5-Triazine, 1,3,5-Trimethylhexahydro-1,3,5-triazine, 3-Amino-1,2,4-triazine, 2-Amino-4,6-dichloro-1,3,5-triazine, 3-Amino-5,6-dimethyl-1,2,4-triazine, 2-Amino-4-methoxy-6-methyl-1,3,5-triazine, 2,4-Diamino-6-methyl-1,3,5-triazine (acetoguanamine), 2,4-Diamino-6-phenyl-1,3,5-triazine (benzoguanamine), 2,4-Diamino-6-hydroxypyrimidine, 3,5-Diamino-1,2,4-triazole, 2,4-Diamino-6-[3-(trifluoromethyl)phenyl]-1,3,5-triazine, 2,5-diamino-1,3,4-thiadiazole, 1,2,3-Triazole-4,5-dicarboxylic acid, amitrol, 3-Amino-1,2,4-triazole-5-thiol, 2,4-Diamino-6-hydroxypyrimidine, 1,2,4-Triazole-3-carboxylic acid, 2,4-Diaminopyrimidine, 2,4,6-Triaminopyrimidine, or triamterene, or combinations thereof. In some embodiments, the nitrogen compound comprises acetoguanamine and/or benzoguanamine. In some cases, the nitrogen compound comprises melamine and/or a melamine-based compound, e.g., melamine, melamine cyanurate, melamine phosphate, and derivatives thereof.

In some embodiments, the flame retardant can optionally contain at least one nitrogen compound selected from the group consisting of condensation products of melamine and/or reaction products of condensation products of melamine with phosphoric acid, and/or mixtures thereof, including for example melam, melem, melon, melamine, melamine cyanurate, melamine phosphate compounds, dimelamine phosphate and/or melamine pyrophosphate, melamine polyphosphate compounds, benzoguanamine compounds, terephthalic ester compounds of tris(hydroxyethyl)isocyanurate, allantoin compounds, glycoluril compounds, ammeline, ammelide, and combinations thereof.

Suitable nitrogen compounds include those of the formula (III) to (VIII) or combinations thereof

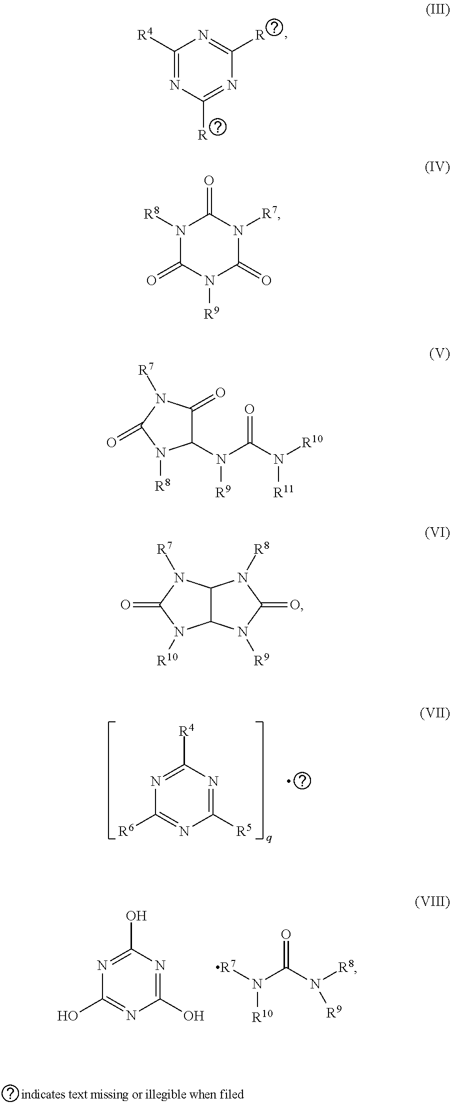

wherein R⁴, R⁵, and R⁶ are independently hydrogen, hydroxy, amino, or mono- or diC₁-C₈alkyl amino; or C₁-C₈alkyl, C₅-C₁₆cycloalkyl, -alkylcycloalkyl, wherein each may be substituted by a hydroxyl or a C₁-C₄hydroxyalkyl, C₂-C₈alkenyl, C₁-C₈alkoxy, -acyl, -acyloxy, C₆-C₂aryl, —OR¹² and —N(R¹²) R¹³ wherein R¹² and R¹³ are each independently hydrogen, C₁-C₈alkyl, C₅-C₁₆cycloalkyl, or -alkylcycloalkyl; or are N-alicyclic or N-aromatic, where N-alicyclic denotes cyclic nitrogen containing compounds such as pyrrolidine, piperidine, imidazolidine, piperazine, and N-aromatic denotes nitrogen containing heteroaromatic ring compounds such as pyrrole, pyridine, imidazole, pyrazine; R⁷, R⁸, R⁹, R¹⁰ and R¹¹ are independently hydrogen, C₁-C₈alkyl, C₅-C₁₆cycloalkyl or -alkyl(cycloalkyl), each may be substituted by a hydroxyl or a C₁-C₄hydroxyalkyl, C₂-C₈alkenyl, C₁-C₈alkoxy, -acyl, -acyloxy, C₆-C₁₂aryl, and —O—R¹²; X is phosphoric acid or pyrophosphoric acid; q is 1, 2, 3, or 4; and b is 1, 2, 3, or 4.

In some embodiments, the nitrogen compound comprises allantoin, glycoluril, melamine, melamine cyanurate, melamine phosphate, melamine pyrophosphate, melamine polyphosphate, or urea cyanurate or combinations thereof. Other exemplary flame retardant systems are disclosed in U.S. Pat. No. 6,365,071.

Some exemplary nitrogen compounds are described, for example in U.S. Pat. Nos. 11,008,458; 11,104,799; and 10,131,757 (and all of their respective progenies), all of which are incorporated by reference herein.

Importantly, the nitrogen compound may have a melting point less than 400° C., e.g., less than 380° C., less than 360° C., less than 340° C., less than 320° C., less than 300° C., less than 280° C., less than 260° C., less than 240° C., less than 220° C., or less than 200° C.

In some embodiments, the nitrogen compound may have an average particle diameter of less than 2 microns. For example, the average particle diameter of the nitrogen compound may be less than 2 micron, e.g., less than 1.5 microns, less than 1 micron, less than 0.9 microns, less than 0.8 microns, less than 0.7 microns, less than 0.6 microns, less than 0.5 microns, less than 0.4 microns, less than 0.3 microns, less than 0.2 microns, less than 0.1 microns, less than 0.05 microns, less than 0.04 microns, or less than 0.3 microns. In terms of lower limits, the average particle diameter of the nitrogen compound may be greater than 0.001 micron, e.g., greater than 0.01 microns, greater than 0.05 microns, greater than 0.1 microns, greater than 0.5 microns. In terms of ranges, the average particle diameter of the nitrogen compound may be from 0.001 to 1 micron, e.g., from 0.01 to 0.9 microns, or from 0.1 to 0.80 microns.

In some cases, the masterbatch or the polymer composition may comprise a non-nitrogen flame retardant.

Some examples of such flame retardants include phosphinate metal salts and/or diphosphinate metal salts. Suitable phosphinate metal salts and diphosphinate metal salts include, for example a phosphinate of the formula (I), a diphosphinate of the formula (II), polymers of the foregoing, or a combination thereof

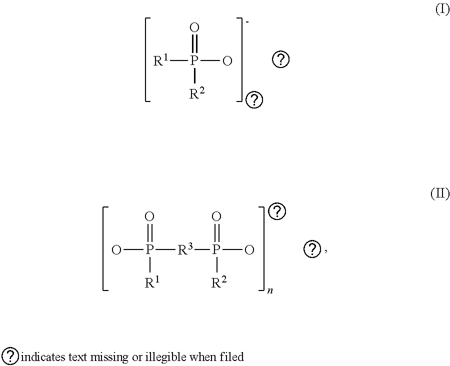

wherein R¹ and R² are each independently hydrogen, a linear or branched C₁-C₆ alkyl radical, or aryl radical; R³ is a linear or branched C₁-C₁₀ alkylene, arylene, alkylarylene, or arylalkylene radical; M is calcium, aluminum, magnesium, strontium, barium, or zinc; m is 2 or 3; n is 1 when x is 1 and m is 2; n is 3 when x is 2 and m is 3. Exemplary commercial products include Exolit OP1230 from Clariant.

Phosphinic salts or phosphinates may include salts of phosphinic and diphosphinic acids and polymers thereof. Exemplary phosphinic acids as a constituent of the phosphinic salts include dimethylphosphinic acid, ethylmethylphosphinic acid, diethylphosphinic acid, methyl-n-propylphosphinic acid, methanedi(methylphosphinic acid), benzene-1,4-(dimethylphosphinic acid), methylphenylphosphinic acid and diphenylphosphinic acid. The salts of the phosphinic acids of the invention can be prepared by known methods that are described in U.S. Pat. Nos. 5,780,534 and 6,013,707.

Exemplary phosphinate metal salts and/or diphosphinate metal salts include aluminum salt of dimethylphosphinic acid, aluminum salt of methylethylphosphinic acid, aluminum salt of methylpropylphosphinic acid.

### AM/AV Compound

The AM/AV compound may vary widely. In some cases, the AM/AV compound may be a zinc compound, a copper compound, and/or a silver compound.

### Zinc Compound

As noted above, the polymer composition includes zinc in a zinc compound and phosphorus in a phosphorus compound, preferably in specific amounts in the polymer composition, to provide the aforementioned structural and antiviral benefits. As used herein, “zinc compound” refers to a compound having at least one zinc molecule or ion (likewise for copper compounds). The ranges and limits may be employed for zinc content and for zinc ion content, and for other metal content, e.g., copper content. The calculation of zinc ion content based on zinc or zinc compound can be made by the skilled chemist, and such calculations and adjustments are contemplated.

It has now been found that the use of specific zinc compounds (and the zinc contained therein) and phosphorus compounds (and the phosphorus contained therein) at specific molar ratios minimizes the negative effects of the zinc compound on the polymer composition. For example, too much zinc compound in the polymer composition can lead to decreased polymer viscosity and inefficiencies in production processes.

The polymer composition may comprise zinc (e.g., in a zinc compound or as zinc ion), e.g., zinc or a zinc compound, dispersed within the polymer composition. In one embodiment, the polymer composition comprises zinc in an amount ranging from 5 wppm to 20,000 wppm, e.g., from 5 wppm to 17,500 wppm, from 5 wppm to 17,000 wppm, from 5 wppm to 16,500 wppm, from 5 wppm to 16,000 wppm, from 5 wppm to 15,500 wppm, from 5 wppm to 15,000 wppm, from 5 wppm to 12,500 wppm, from 5 wppm to 10,000 wppm, from 5 wppm to 5000 wppm, from 5 wppm to 4000 wppm, e.g., from 5 wppm to 3000 wppm, from 5 wppm to 2000 wppm, from 5 wppm to 1000 wppm, from 5 wppm to 500 wppm, from 10 wppm to 20,000 wppm, from 10 wppm to 17,500 wppm, from 10 wppm to 17,000 wppm, from 10 wppm to 16,500 wppm, from 10 wppm to 16,000 wppm, from 10 wppm to 15,500 wppm, from 10 wppm to 15,000 wppm, from 10 wppm to 12,500 wppm, from 10 wppm to 10,000 wppm, from 10 wppm to 5000 wppm, from 10 wppm to 4000 wppm, from 10 wppm to 3000 wppm, from 10 wppm to 2000 wppm, from 10 wppm to 1000 wppm, from 10 wppm to 500 wppm, from 50 wppm to 20,000 wppm, from 50 wppm to 17,500 wppm, from 50 wppm to 17,000 wppm, from 50 wppm to 16,500 wppm, from 50 wppm to 16,000 wppm, from 50 wppm to 15,500 wppm, from 50 wppm to 15,000 wppm, from 50 wppm to 12,500 wppm, from 50 wppm to 10,000 wppm, from 50 wppm to 5000 wppm, from 50 wppm to 4000 wppm, from 50 wppm to 3000 wppm, from 50 wppm to 2000 wppm, from 50 wppm to 1000 wppm, from 50 wppm to 500 wppm, from 100 wppm to 20,000 wppm, from 100 wppm to 17,500 wppm, from 100 wppm to 17,000 wppm, from 100 wppm to 16,500 wppm, from 100 wppm to 16,000 wppm, from 100 wppm to 15,500 wppm, from 100 wppm to 15,000 wppm, from 100 wppm to 12,500 wppm, from 100 wppm to 10,000 wppm, from 100 wppm to 5000 wppm, from 100 wppm to 4000 wppm, from 100 wppm to 3000 wppm, from 100 wppm to 2000 wppm, from 100 wppm to 1000 wppm, from 100 wppm to 500 wppm, from 200 wppm to 20,000 wppm, from 200 wppm to 17,500 wppm, from 200 wppm to 17,000 wppm, from 200 wppm to 16,500 wppm, from 200 wppm to 16,000 wppm, from 200 wppm to 15,500 wppm, from 200 wppm to 15,000 wppm, from 200 wppm to 12,500 wppm, from 200 wppm to 10,000 wppm, from 200 wppm to 5000 wppm, from 200 wppm to 4000 wppm, 5000 wppm to 20000 wppm, from 200 wppm to 3000 wppm, from 200 wppm to 2000 wppm, from 200 wppm to 1000 wppm, from 200 wppm to 500 wppm, from 10 wppm to 900 wppm, from 200 wppm to 900 wppm, from 425 wppm to 600 wppm, from 425 wppm to 525 wppm, from 350 wppm to 600 wppm, from 375 wppm to 600 wppm, from 375 wppm to 525 wppm, from 480 wppm to 600 wppm, from 480 wppm to 525 wppm, from 600 wppm to 750 wppm, or from 600 wppm to 700 wppm.

In terms of lower limits, the polymer composition may comprise greater than 5 wppm of zinc, e.g., greater than 10 wppm, greater than 50 wppm, greater than 100 wppm, greater than 200 wppm, greater than 300 wppm, greater than 350 wppm, greater than 375 wppm, greater than 400 wppm, greater than 425 wppm, greater than 480 wppm, greater than 500 wppm, or greater than 600 wppm.

In terms of upper limits, the polymer composition may comprise less than 20,000 wppm of zinc, e.g., less than 17,500 wppm, less than 17,000 wppm, less than 16,500 wppm, less than 16,000 wppm, less than 15,500 wppm, less than 15,000 wppm, less than 12,500 wppm, less than 10,000 wppm, less than 5000 wppm, less than less than 4000 wppm, less than 3000 wppm, less than 2000 wppm, less than 1000 wppm, less than 500 wppm, less than 400 wppm, less than 330 wppm, less than 300. In some aspects, the zinc compound is embedded in the polymer formed from the polymer composition.

The ranges and limits are applicable to both zinc in elemental or ionic form and to zinc compound). The same is true for other ranges and limits disclosed herein relating to other metals, e.g., copper. For example, the ranges may relate to the amount of zinc ions dispersed in the polymer.

The zinc of the polymer composition is present in or provided via a zinc compound, which may vary widely. The zinc compound may comprise zinc oxide, zinc ammonium adipate, zinc acetate, zinc ammonium carbonate, zinc stearate, zinc phenyl phosphinic acid, or zinc pyrithione, or combinations thereof. In some embodiments, the zinc compound comprises zinc oxide, zinc ammonium adipate, zinc acetate, or zinc pyrithione, or combinations thereof. In some embodiments, the zinc compound comprises zinc oxide, zinc stearate, or zinc ammonium adipate, or combinations thereof. In some aspects, the zinc is provided in the form of zinc oxide. In some aspects, the zinc is not provided via zinc phenyl phosphinate and/or zinc phenyl phosphonate.

It has also been found that the polymer compositions surprisingly may benefit from the use of specific zinc compounds. In particular, the use of zinc compounds prone to forming ionic zinc (e.g., Zn²⁺) may increase the antiviral properties of the polymer composition. It is theorized that the ionic zinc disrupts the replicative cycle of the virus. For example, the ionic zinc may interfere with (e.g., inhibit) viral protease or polymerase activity. Further discussion of the effect of ionic zinc on viral activity is found in Velthuis et al., Zn Inhibits Coronavirus and Arterivirus RNA Polymerase Activity In Vitro and Zinc Ionophores Block the Replication of These Viruses in Cell Culture, PLOS Pathogens (November 2010), which is incorporated herein by reference.

The amount of the zinc compound present in the polymer compositions may be discussed in relation to the ionic zinc content. In one embodiment, the polymer composition comprises ionic zinc, e.g., Zn²⁺, in an amount ranging from 1 ppm to 30,000 ppm, e.g., from 1 ppm to 25,000 ppm, from 1 ppm to 20,000 ppm, from 1 ppm to 15,000 ppm, from 1 ppm to 10,000 ppm, from 1 ppm to 5,000 ppm, from 1 ppm to 2,500 ppm, from 50 ppm to 30,000 ppm, from 50 ppm to 25,000 ppm, from 50 ppm to 20,000 ppm, from 50 ppm to 15,000 ppm, from 50 ppm to 10,000 ppm, from 50 ppm to 5,000 ppm, from 50 ppm to 2,500 ppm, from 100 ppm to 30,000 ppm, from 100 ppm to 25,000 ppm, from 100 ppm to 20,000 ppm, from 100 ppm to 15,000 ppm, from 100 ppm to 10,000 ppm, from 100 ppm to 5,000 ppm, from 100 ppm to 2,500 ppm, from 150 ppm to 30,000 ppm, from 150 ppm to 25,000 ppm, from 150 ppm to 20,000 ppm, from 150 ppm to 15,000 ppm, from 150 ppm to 10,000 ppm, from 150 ppm to 5,000 ppm, from 150 ppm to 2,500 ppm, from 250 ppm to 30,000 ppm, from 250 ppm to 25,000 ppm, from 250 ppm to 20,000 ppm, from 250 ppm to 15,000 ppm, from 250 ppm to 10,000 ppm, from 250 ppm to 5,000 ppm, or from 250 ppm to 2,500 ppm. In some cases, the ranges and limits mentioned above for zinc may also be applicable to ionic zinc content.

In some cases, the use of zinc provides for processing and or end use benefits. Other antiviral agents, e.g., copper or silver, may be used, but these often include adverse effects (e.g., on the relative viscosity of the polymer composition, toxicity, and health or environmental risk). In some situations, the zinc does not have adverse effects on the relative viscosity of the polymer composition. Also, the zinc, unlike other antiviral agents, e.g., silver, does not present toxicity issues (and in fact may provide health advantages, such as immune system support). In addition, as noted herein, the use of zinc provides for the reduction or elimination of leaching into other media and/or into the environment. This both prevents the risks associated with introducing zinc into the environment and allows the polymer composition to be reused-zinc provides surprising “green” advantages over conventional, e.g., silver-containing, compositions.

Advantageously, it has been discovered that adding the above identified zinc compounds and phosphorus compounds may result in a beneficial relative viscosity (RV) of the polymer composition. In some embodiments, the RV of the polymer composition ranges from 5 to 80, e.g., from 5 to 70, from 10 to 70, from 15 to 65, from 20 to 60, from 30 to 50, from 10 to 35, from 10 to 20, from 60 to 70, from 50 to 80, from 40 to 50, from 30 to 60, from 5 to 30, or from 15 to 32. In terms of lower limits, the RV of the polymer composition may be greater than 5, e.g., greater than 10, greater than 15, greater than 20, greater than 25, greater than 27.5, or greater than 30. In terms of upper limits, the RV of the polymer composition may be less than 70, e.g., less than 65, less than 60, less than 50, less than 40, or less than 35.

To calculate RV, a polymer may be dissolved in a solvent (usually formic or sulfuric acid), the viscosity is measured, then the viscosity is compared to the viscosity of the pure solvent. This give a unitless measurement. Solid materials, as well as liquids, may have a specific RV. The fibers/fabrics produced from the polymer compositions may have the aforementioned relative viscosities, as well.

It has been determined that a specific amount of the zinc compound and the phosphorus compound can be mixed in a polymer composition, e.g., polyamide composition, in finely divided form, such as in the form of granules, flakes and the like, to provide a polymer composition that can be subsequently formed, e.g., extruded, molded or otherwise drawn, into various products (e.g., high-contact products, surface layers of high-contact products) by conventional methods to produce products having substantially improved antimicrobial activity. The zinc and phosphorus are employed in the polymer composition in the aforementioned amounts to provide a fiber with improved antimicrobial activity retention (near-permanent).

### Copper Compound

As noted above, the polymer composition, in some embodiments, includes copper (provided via a copper compound). As used herein, “copper compound” refers to a compound having at least one copper molecule or ion.

In some cases, the copper compound may improve, e.g., enhance the antiviral properties of the polymer composition. In some cases, the copper compound may affect other characteristics of the polymer composition, e.g., antimicrobial activity or physical characteristics.

The polymer composition may comprise copper (e.g., in a copper compound), e.g., copper or a copper compound, dispersed within the polymer composition. In one embodiment, the polymer composition comprises copper in an amount ranging from 5 wppm to 20,000 wppm, e.g., from 5 wppm to 17,500 wppm, from 5 wppm to 17,000 wppm, from 5 wppm to 16,500 wppm, from 5 wppm to 16,000 wppm, from 5 wppm to 15,500 wppm, from 5 wppm to 15,000 wppm, from 5 wppm to 12,500 wppm, from 5 wppm to 10,000 wppm, from 5 wppm to 5000 wppm, from 5 wppm to 4000 wppm, e.g., from 5 wppm to 3000 wppm, from 5 wppm to 2000 wppm, from 5 wppm to 1000 wppm, from 5 wppm to 500 wppm, from 5 wppm to 100 wppm, from 5 wppm to 50 wppm, from 5 wppm to 35 wppm, from 10 wppm to 20,000 wppm, from 10 wppm to 17,500 wppm, from 10 wppm to 17,000 wppm, from 10 wppm to 16,500 wppm, from 10 wppm to 16,000 wppm, from 10 wppm to 15,500 wppm, from 10 wppm to 15,000 wppm, from 10 wppm to 12,500 wppm, from 10 wppm to 10,000 wppm, from 10 wppm to 5000 wppm, from 10 wppm to 4000 wppm, from 10 wppm to 3000 wppm, from 10 wppm to 2000 wppm, from 10 wppm to 1000 wppm, from 10 wppm to 500 wppm, from 50 wppm to 20,000 wppm, from 50 wppm to 17,500 wppm, from 50 wppm to 17,000 wppm, from 50 wppm to 16,500 wppm, from 50 wppm to 16,000 wppm, from 50 wppm to 15,500 wppm, from 50 wppm to 15,000 wppm, from 50 wppm to 12,500 wppm, from 50 wppm to 10,000 wppm, from 50 wppm to 5000 wppm, from 50 wppm to 4000 wppm, from 50 wppm to 3000 wppm, from 50 wppm to 2000 wppm, from 50 wppm to 1000 wppm, from 50 wppm to 500 wppm, from 100 wppm to 20,000 wppm, from 100 wppm to 17,500 wppm, from 100 wppm to 17,000 wppm, from 100 wppm to 16,500 wppm, from 100 wppm to 16,000 wppm, from 100 wppm to 15,500 wppm, from 100 wppm to 15,000 wppm, from 100 wppm to 12,500 wppm, from 100 wppm to 10,000 wppm, from 100 wppm to 5000 wppm, from 100 wppm to 4000 wppm, from 100 wppm to 3000 wppm, from 100 wppm to 2000 wppm, from 100 wppm to 1000 wppm, from 100 wppm to 500 wppm, from 200 wppm to 20,000 wppm, from 200 wppm to 17,500 wppm, from 200 wppm to 17,000 wppm, from 200 wppm to 16,500 wppm, from 200 wppm to 16,000 wppm, from 200 wppm to 15,500 wppm, from 200 wppm to 15,000 wppm, from 200 wppm to 12,500 wppm, from 200 wppm to 10,000 wppm, from 200 wppm to 5000 wppm, from 200 wppm to 4000 wppm, from 200 wppm to 3000 wppm, from 200 wppm to 2000 wppm, from 200 wppm to 1000 wppm, or from 200 wppm to 500 wppm.

In terms of lower limits, the polymer composition may comprise greater than 5 wppm of copper, e.g., greater than 10 wppm, greater than 50 wppm, greater than 100 wppm, greater than 200 wppm, or greater than 300 wppm. In terms of upper limits, the polymer composition may comprise less than 20,000 wppm of copper, e.g., less than 17,500 wppm, less than 17,000 wppm, less than 16,500 wppm, less than 16,000 wppm, less than 15,500 wppm, less than 15,000 wppm, less than 12,500 wppm, less than 10,000 wppm, less than 5000 wppm, less than less than 4000 wppm, less than 3000 wppm, less than 2000 wppm, less than 1000 wppm, less than 500 wppm less than 100 wppm, less than 50 wppm, less than 35 wppm. In some aspects, the copper compound is embedded in the polymer formed from the polymer composition.

The composition of the copper compound is not particularly limited. Suitable copper compounds include copper iodide, copper bromide, copper chloride, copper fluoride, copper oxide, copper stearate, copper ammonium adipate, copper acetate, or copper pyrithione, or combinations thereof. The copper compound may comprise copper oxide, copper ammonium adipate, copper acetate, copper ammonium carbonate, copper stearate, copper phenyl phosphinic acid, or copper pyrithione, or combinations thereof. In some embodiments, the copper compound comprises copper oxide, copper ammonium adipate, copper acetate, or copper pyrithione, or combinations thereof. In some embodiments, the copper compound comprises copper oxide, copper stearate, or copper ammonium adipate, or combinations thereof. In some aspects, the copper is provided in the form of copper oxide. In some aspects, the copper is not provided via copper phenyl phosphinate and/or copper phenyl phosphonate.

In one embodiment, the molar ratio of the copper to the zinc is greater than 0.01:1, e.g., greater than 0.05:1, greater than 0.1:1, greater than 0.15:1, greater than 0.25:1, greater than 0.5:1, or greater than 0.75:1. In terms of ranges, the molar ratio of the copper to the zinc in the polymer composition may range from 0.01:1 to 15:1, e.g., from 0.05:1 to 10:1, from 0.1:1 to 9:1, from 0.15:1 to 8:1, from 0.25:1 to 7:1, from 0.5:1 to 6:1, from 0.75:1 to 5:1 from 0.5:1 to 4:1, or from 0.5:1 to 3:1. In terms of upper limits, the molar ratio of zinc to copper in the polymer composition may be less than 15:1, e.g., less than 10:1, less than 9:1, less than 8:1, less than 7:1, less than 6:1, less than 5:1, less than 4:1, or less than 3:1. In some cases, copper is bound in the polymer matrix along with zinc.

In some embodiments, the use of cuprous ammonium adipate has been found to be particularly effective in activating copper ions into the polymer matrix.

### Silver Compound

In some cases, the polymer composition includes silver (optionally provided via a silver compound). As used herein, “silver compound” refers to a compound having at least one silver molecule or ion. The silver may be in ionic form. The ranges and limits for silver may be similar to the ranges and limits for copper (discussed above).

Similarly, the use of silver ammonium adipate has been found to be particularly effective in activating silver ions into the polymer matrix. It is found that dissolving copper (I) or copper (II) compounds in ammonium adipate is particularly efficient at generating copper (I) or copper (II) ions. The same is true for dissolving Ag (I) or Ag (III) compounds in ammonium adipate to generate Ag¹⁺ or Ag³⁺ ions.

### Fibers/Fabric Polymer Composition

As noted above, the fibers/fabrics comprise (or are formed from) a polymer composition comprising a polymer along with the masterbatch. In some cases, the fibers comprise all fibers made from a single type of polymer. In some cases, the fibers comprise multiple types of fibers, e.g., polyamide fibers and cotton fibers.

### Polymer

The fiber/fabric composition comprises a polymer, which, in some embodiments, is a polymer suitable for producing fibers and fabrics. In one embodiment, the polymer composition comprises a polymer in an amount ranging from 50 wt. % to 100 wt. %, e.g., from 50 wt. % to 99.99 wt. %, from 50 wt. % to 99.9 wt. %, from 50 wt. % to 99 wt. % from 55 wt. % to 100 wt. %, from 55 wt. % to 99.99 wt. %, from 55 wt. % to 99.9 wt. %, from 55 wt. % to 99 wt. %, from 60 wt. % to 100 wt. %, from 60 wt. % to 99.99 wt. %, from 60 wt. % to 99.9 wt. %, from 60 wt. % to 99 wt. %., from 65 wt. % to 100 wt. %, from 65 wt. % to 99.99 wt. %, from 65 wt. % to 99.9 wt. %, or from 65 wt. % to 99 wt. %. In terms of upper limits, the polymer composition may comprise less than 100 wt. % of the polymer, e.g., less than 99.99 wt. %, less than 99.9 wt. %, or less than 99 wt. %. In terms of lower limits, the polymer composition may comprise greater than 50 wt. % of the polymer, e.g., greater than 55 wt. %, greater than 60 wt. %, or greater than 65 wt. %.

The polymer of the fiber/fabric polymer composition may vary widely. The polymer may include but is not limited to, a thermoplastic polymer, polyester, nylon, rayon, polyamide 6, polyamide 6,6, polyethylene (PE), polypropylene (PP), polyethylene terephthalate (PET), polyethylene terephthalate glycol (PETG), co-PET, polybutylene terephthalate (PBT) polylactic acid (PLA), and polytrimethylene terephthalate (PTT). In some embodiments, the polymer may be polyamide, e.g., PA6 and/or PA6,6. In some cases, nylon is known to be a stronger fiber than PET and exhibits a non-drip burning characteristic that is beneficial, e.g., in automotive textile applications, and is more hydrophilic than PET. In some cases, the polymer comprises a polyamide and/or a polyester, e.g., a polyamide or a polyester.

In some cases, the polymer composition may comprise polyamides. Common polyamides include nylons and aramids. For example, the polyamide may comprise PA-4T/41; PA-4T/61; PA-5T/51; PA-6; PA6,6; PA6,6/6; PA6,6/6T; PA-6T/61; PA-6T/61/6; PA-6T/6; PA-6T/61/66; PA-6T/MPMDT (where MPMDT is polyamide based on a mixture of hexamethylene diamine and 2-methylpentamethylene diamine as the diamine component and terephthalic acid as the diacid component); PA-6T/66; PA-6T/610; PA-10T/612; PA-10T/106; PA-6T/612; PA-6T/10T; PA-6T/101; PA-9T; PA-10T; PA-12T; PA-10T/101; PA-10T/12; PA-10T/11; PA-6T/9T; PA-6T/12T; PA-6T/10T/61; PA-6T/61/6; PA-6T/61/12; and copolymers, blends, mixtures and/or other combinations thereof. Additional suitable polyamides, additives, and other components are disclosed in U.S. patent application Ser. No. 16/003,528. In some cases, the polymer comprises PA6, or PA 6,6, or combinations thereof.

The polymer composition may also comprise polyamides produced through the ring-opening polymerization or polycondensation, including the copolymerization and/or copolycondensation, of lactams. Without being bound by theory, these polyamides may include, for example, those produced from propriolactam, butyrolactam, valerolactam, and caprolactam. For example, in some embodiments, the polyamide is a polymer derived from the polymerization of caprolactam. In those embodiments, the polymer comprises at least 10 wt. % caprolactam, e.g., at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, or at least 60 wt. %. In some embodiments, the polymer includes from 10 wt. % to 60 wt. % of caprolactam, e.g., from 15 wt. % to 55 wt. %, from 20 wt. % to 50 wt. %, from 25 wt. % to 45 wt. %, or from 30 wt. % to 40 wt. %. In some embodiments, the polymer comprises less than 60 wt. % caprolactam, e.g., less than 55 wt. %, less than 50 wt. %, less than 45 wt. %, less than 40 wt. %, less than 35 wt. %, less than 30 wt. %, less than 25 wt. %, less than 20 wt. %, or less than 15 wt. %. Furthermore, the polymer composition may comprise the polyamides produced through the copolymerization of a lactam with a nylon, for example, the product of the copolymerization of a caprolactam with PA6,6.

In some embodiments, the polymer can be formed by conventional polymerization of the polymer composition in which an aqueous solution of at least one diamine-carboxylic acid salt is heated to remove water and effect polymerization to form an antiviral nylon. This aqueous solution is preferably a mixture which includes at least one polyamide-forming salt in combination with the other components described herein to produce a polymer composition. Conventional polyamide salts are formed by reaction of diamines with dicarboxylic acids with the resulting salt providing the monomer. In some embodiments, a preferred polyamide-forming salt is hexamethylenediamine adipate (nylon 6,6 salt) formed by the reaction of equimolar amounts of hexamethylenediamine and adipic acid.

In some embodiments, the polyamide comprises a combination of PA-6, PA6,6, and PA6,6/6T. In these embodiments, the polyamide may comprise from 1 wt. % to 99 wt. % PA-6, from 30 wt. % to 99 wt. % PA6,6, and from 1 wt. % to 99 wt. % PA6,6/6T. In some embodiments, the polyamide comprises one or more of PA-6, PA6,6, and PA6,6/6T. In some aspects, the polymer composition comprises 6 wt. % of PA-6 and 94 wt. % of PA6,6. In some aspects, the polymer composition comprises copolymers or blends of any of the polyamides mentioned herein.

In some cases, the polymer compositions may comprise polyethylene. Suitable examples of polyethylene include linear low-density polyethylene (LLDPE), low-density polyethylene (LDPE), medium-density polyethylene (MDPE), high-density polyethylene (HDPE), and ultra-high-molecular-weight polyethylene (UHMWPE).

In some cases, the polymer compositions may comprise polycarbonate (PC). For example, the polymer composition may comprise a blend of polycarbonate with other polymers, e.g., a blend of polycarbonate and acrylonitrile butadiene styrene (PC-ABS), a blend of polycarbonate and polyvinyl toluene (PC-PVT), a blend of polycarbonate and polybutylene terephthalate (PC-PBT), a blend of polycarbonate and polyethylene terephthalate (PC-PET), or combinations thereof.

The polymer composition may, in some embodiments, comprise a combination of polymers, e.g., a combination polyamides and/or polyesters. By combining various polyamides, the final composition may be able to incorporate the desirable properties, e.g., mechanical properties, of each constituent.

Additional exemplary polymers are described, for example in U.S. Pat. Nos. 11,008,458; 11,104,799; and 10,131,757.

In some cases, the fibers may be made from AM/AV polymer compositions, and as such, will have AM/AV properties. AM/AV polymer compositions and fibers, filaments, yarns, matrices, and fabrics made there from are described, for example in U.S. Pat. Nos. 11,185,071; 11,505,701; and 10,662,561, along with U.S. patent application Ser. Nos. 17/192,491; 17/192,513; and Ser. No. 17/192,533 (and all of their respective progenies), all of which are incorporated by reference herein. The nitrogen compound may be employed in the AM/AV polymer compositions.

In some cases, the fibers may be formed via the processes and polymer compositions disclosed in U.S. Pat. No. 10,662,561 to Dr. Wai-shing Yung (and all of its progenies), all of which are incorporated by reference herein. The nitrogen compound may be employed in the polymer compositions disclosed therein and may be processed as disclosed therein.

In some cases, the fibers may be formed via the processes disclosed in US Patent Publication No. 2017/0314168 and WO2017176604A1 (and all of their progenies), all of which are incorporated by reference herein. The nitrogen compound may be employed in the polymer compositions disclosed therein and may be processed as disclosed therein.

In some embodiments, the fibers comprise multiple types of fibers, e.g., first fibers such as polyamide fibers and second fibers such as cotton fibers. In these cases, the first fibers be made from (may comprise) a first fiber/fabric composition comprising a first polymer, and the second fibers be made from (may comprise) a second fiber/fabric composition comprising a second polymer. Additional fibers are contemplated in the fiber matrix, e.g., third fibers, fourth fibers, and so on. In some embodiments, the first fibers may be made from a first fiber/fabric composition comprising a polyamide. In some embodiments, the second fibers may be made from a second fiber/fabric composition comprising cotton or an olefin polymer.

In some embodiments, the aforementioned forming step may comprise forming first fibers comprising a first polymer and a first flame retardant masterbatch and combining the first fibers with second fibers. The combining may be achieved by twisting or mixing followed by spinning. One example fabric is the NyCo fabric. In some cases, e.g., for continuous fibers, a bundle of nylon yarn may be twisted together with a bundle of cotton yarn to form a bundle of (continuous) blended yarn. In some cases, e.g., for staple fibers, the short cotton staples are well mixed with nylon staples, then the mixture of the two types of staples will be formed mechanically into a bundle of yarn.

In some embodiments, the first fibers comprise a first polymer, e.g., polyamide, and a first flame retardant masterbatch and combining the first fibers with second fibers, which comprise cotton.

In some embodiments, the RV of the fiber/fabric polymer composition (as measured via the formic acid method) ranges from 2 to 100, e.g., from 2 to 80, from 5 to 70, from 15 to 65, from 20 to 60, from 30 to 50, from 10 to 35, from 10 to 20, from 60 to 70, from 50 to 80, from 40 to 50, from 30 to 60, from 5 to 30, or from 15 to 32. In terms of lower limits, the RV of the fiber/fabric polymer composition may be greater than 5, e.g., greater than 10, greater than 15, greater than 20, greater than 25, greater than 27.5, greater than 30, greater than 35, greater than 40, greater than 45, greater than 50, greater than 55, or greater than 60. In terms of upper limits, the RV of the fiber/fabric polymer composition may be less than 200, e.g., less than 150, less than 125, less than 100, less than 90, less than 75, less than 65, less than 60, less than 50, less than 40, or less than 35. The relative of the fabric/fiber polymer composition contributes to processability and to the mechanical performance.

To calculate RV, a polymer may be dissolved in a solvent (usually formic or sulfuric acid), the viscosity is measured, then the viscosity is compared to the viscosity of the pure solvent. This give a unitless measurement. Solid materials, as well as liquids, may have a specific RV. The fibers/fabrics produced from the polymer compositions may have the aforementioned relative viscosities, as well.

In some embodiments, the fiber/fabric composition (or the fiber/yarn/fabric made therefrom) has a fabric weight less than 300 g/m², at a thickness of less than 0.35 mm, e.g., less than 290 g/m², less than 275 g/m², less than 270 g/m², less than 250 g/m², less than 235 g/m², less than 225 g/m², less than 220 g/m², less than 210 g/m², less than 200 g/m², less than 190 g/m², or less than 175 g/m². In some cases, the fiber/fabric composition (or the fiber/yarn/fabric made therefrom) has a fabric weight greater than 1 g/m², e.g., greater than 3 g/m², greater than 5 g/m², greater than 10 g/m², greater than 25 g/m², greater than 50 g/m², greater than 75 g/m², or greater than 100 g/m².

The fabric (or yarn that make up the fabrics) may comprise fibers, and in some cases, may comprise multiple types of fibers (see discussion regarding types of polymers).

### Optional Crosslinking Agent

In some cases, the polymer composition comprises a crosslinking agent that promotes crosslinking of the monomers, oligomers, and polymers. The addition of the crosslinker provides for unexpected benefits in both mechanical performance and flame retardancy.

In some embodiments, the crosslinking agent has the ability to form free radicals under beta or gamma radiation. In some cases, the crosslinking agents contain two or more unsaturated groups including olefin groups. Suitable unsaturated groups include acryloyl, methacryloyl, vinyl, and allyl. Exemplary polyallylic compounds useful as crosslinking agents include those compounds comprising two or more allylic groups, for example, triallylisocyanurate (TAIC), triallylcyanurate (TAC), trimethylallyl isocyanurate (TMIC), and combinations thereof.

As used herein, (meth)acryloy includes both acryloyl and methacryloyl functionality. The crosslinking agents can include polyol poly(meth)acrylates, which are typically prepared from aliphatic diols, triols and/or tetraols containing 2-100 carbon atoms. Examples of suitable polyol poly(meth)acrylates include ethylene glycol diacrylate, 1,6-hexanediol diacrylate, neopentylglycol di(meth)acrylate, ethylene glycol dimethacrylate (EDMA), polyethyleneglycol di(meth)acrylates, polypropyleneglycol di(meth)acrylates, polybutyleneglycol di(meth)acrylates, 2,2-bis(4-(meth)acryloxyethoxyphenyl) propane, 2,2-bis(4-(meth)acryloxydiethoxyphenyl) propane, pentaerythritol tri(meth)acrylate, pentaerythritol tetra(meth)acrylate, dipentaerythritol penta(meth)acrylate, dipentaerythritol hexa(meth)acrylate, trimethylolpropane trimethacrylate, trimethylolpropane triacrylate (TMPTA), di(trimethylolpropane) tetra(meth)acrylate, and combinations thereof. N,N′-alkylenebisacrylamides are also contemplated.

In some cases, the polymer composition comprises a reactive crosslinking agent, e.g., 9,10-dihydro-9-oxy-10-phosphaphenanthrene-10-oxide (DOPO), optionally epoxy modified. Additionally non-limiting examples include multifunctional epoxy molecules such as Trimethylolethane Triglycidyl Ether, SU8, and/or Erisys GE-31, GE-30, GE-40, GE-38, and GE-60 (CVC Chemicals). Other potential candidates include, but are not limited to, crosslinking agent may be one or more of those disclosed in U.S. Pat. Nos. 11,008,458; 11,104,799; and 10,131,757.

In some embodiments, the polymer composition comprises the crosslinking agent in an amount ranging from 0.01 to 20 weight percent, e.g., from 0.1 wt % to 15 wt %, from 0.1 wt % to 10 wt %, from 0.5 wt % to 10 wt %, from 0.5 wt % to 5 wt %, from 1.0 wt % to 5 wt %, or from 1.5 wt % to 4 wt %. In some cases, the fiber/fabric composition may comprise greater than 0.01 wt % crosslinking agent, e.g., greater than 0.1 wt %, greater than 0.3 wt %, greater than 0.5 wt %, greater than 0.7 wt %, greater than 1.0 wt %, greater than 3.0 wt %, greater than 5.0 wt %, greater than 7.0 wt %, or greater than 10 wt %. In some cases, the fiber/fabric composition may comprise less than 20 wt % crosslinking agent, e.g., less than 15 wt %, less than 12 wt %, less than 10 wt %, less than 7 wt %, less than 5 wt %, less than 3 wt %, less than 1 wt %, less than 0.5 wt %, or less than 0.1 wt %.

### Additional Components

In some embodiments, the polymer composition may comprise additional additives. The additives include pigments, hydrophilic or hydrophobic additives, anti-odor additives, additional antiviral agents, and antimicrobial/anti-fungal inorganic compounds, such as copper, zinc, tin, and silver.

In some embodiments, the polymer composition can be combined with color pigments for coloration for the use in fabrics or other components formed from the polymer composition. In some aspects, the polymer composition can be combined with UV additives to withstand fading and degradation in fabrics exposed to significant UV light. In some aspects, the polymer composition can be combined with additives to make the surface of the fiber hydrophilic or hydrophobic. In some aspects, the polymer composition can be combined with a hygroscopic material, e.g., to make the fiber, fabric, or other products formed therefrom more hygroscopic. In some aspects, the polymer composition can be combined with additives to make the fabric flame retardant or flame resistant. In some aspects, the polymer composition can be combined with additives to make the fabric stain resistant. In some aspects, the polymer composition can be combined with pigments with the antimicrobial compounds so that the need for conventional dyeing and disposal of dye materials is avoided.

In some embodiments, the polymer composition may further comprise colored materials, such as carbon black, copper phthalocyanine pigment, lead chromate, iron oxide, chromium oxide, and ultramarine blue.

Fillers may also be employed to the extent desired. Fillers are not required components. Many fillers are known including, but not limited to, glass fibers, such as E, A, C, ECR, R, S, D, and NE glasses and quartz, and the like may be used as the reinforcing filler. Other suitable glass fibers include milled glass fiber, chopped glass fiber, and long glass fiber (for instance those used in a pultrusion process). Other suitable inorganic fibrous fillers include those derived from blends comprising at least one of aluminum silicates, aluminum oxides, magnesium oxides, and calcium sulfate hemihydrate. Also included among fibrous fillers are single crystal fibers or “whiskers” including silicon carbide, alumina, boron carbide, iron, nickel, or copper. Other suitable inorganic fibrous fillers include carbon fibers, stainless steel fibers, metal coated fibers, and the like.

In one embodiment, the polymer composition comprises the additives (individually or in total) in an amount ranging from 0.01 wt. % to 30 wt. %, e.g., 0.1 wt. % to 25 wt. %, from 0.1 to 15 wt. %, from 0.5 wt. % to 10 wt. %, from 1 wt. % to 10 wt. %, or from 1 wt. % to 8 wt. %. In terms of upper limits, the polymer composition may comprise less than 30 wt. % additives, e.g., less than 25 wt. %, less than 20 wt. %, less than 15 wt. %, less than 10 wt %, less than 8 wt %, less than 5 wt %, less than 3 wt %, or less than 1 wt %. In terms of lower limits, the polymer composition may comprise greater than 0.01 wt. % delusterant, e.g., greater than 0.05 wt. %, greater than 0.1 wt. %, greater than 0.5 wt. %, greater than 1 wt %, or greater than 3 wt %.

### Method of Making Fibers and Fabrics

The fibers/fabrics may be formed from the fiber/fabric composition. And the method and steps for producing the fibers/fabrics/matrices themselves may vary widely. Exemplary non-limiting processes are discussed herein. These processes differ from those employed to produce molded products.

As noted above, the fibers or fabrics are made by forming the fiber/fabric polymer composition into the fibers, which are arranged to form the fabric or matrix.

All or some of the ingredients may be added initially to the processing system, or else certain additives may be pre-compounded with one or more of the primary components. The other ingredients may include some of the polymer used to prepare the composition, while the remaining portion of the polymer is fed through a port downstream. This disclosure contemplates the reaction products of the above-described compositions, including the crosslinked products.

In one embodiment, the polymer, optional crosslinking agent, and flame retardant may be combined to form a blend.

In some aspects, fibers, e.g., polyamide fibers, are made by spinning a polyamide composition formed in a melt polymerization process. During the melt polymerization process of the polyamide composition, an aqueous monomer solution, e.g., salt solution, is heated under controlled conditions of temperature, time and pressure to evaporate water and effect polymerization of the monomers, resulting in a polymer melt. During the melt polymerization process, sufficient amounts of components are employed in the aqueous monomer solution to form the polyamide mixture before polymerization. The monomers are selected based on the desired polyamide composition. The polymerized polyamide can subsequently be spun into fibers, e.g., by melt, solution, centrifugal, or electro-spinning.

In some embodiments, the process includes preparing an aqueous monomer solution. The aqueous monomer solution may comprise amide monomers. In some embodiments, the concentration of monomers in the aqueous monomer solution is less than 60 wt %, e.g., less than 58 wt %, less than 56.5 wt %, less than 55 wt %, less than 50 wt %, less than 45 wt %, less than 40 wt %, less than 35 wt %, or less than 30 wt %. In some embodiments, the concentration of monomers in the aqueous monomer solution is greater than 20 wt %, e.g., greater than 25 wt %, greater than 30 wt %, greater than 35 wt %, greater than 40 wt %, greater than 45 wt %, greater than 50 wt %, greater than 55 wt %, or greater than 58 wt %. In some embodiments, the concentration of monomers in the aqueous monomer solution is in a range from 20 wt % to 60 wt %, e.g., from 25 wt % to 58 wt %, from 30 wt % to 56.5 wt %, from 35 wt % to 55 wt %, from 40 wt % to 50 wt %, or from 45 wt % to 55 wt %. The balance of the aqueous monomer solution may comprise water and/or additional additives. In some embodiments, the monomers comprise amide monomers including a diacid and a diamine, e.g., nylon salt.

In some embodiments, the aqueous monomer solution is a nylon salt solution. The nylon salt solution may be formed by mixing a diamine and a diacid with water. For example, water, diamine, and dicarboxylic acid monomer are mixed to form a salt solution, e.g., mixing adipic acid and hexamethylene diamine with water. In some embodiments, the diacid may be a dicarboxylic acid and may be selected from the group consisting of oxalic acid, malonic acid, succinic acid, glutaric acid, pimelic acid, adipic acid, suberic acid, azelaic acid, sebacic acid, undecanedioic acid, dodecandioic acid, maleic acid, glutaconic acid, traumatic acid, and muconic acid, 1,2- or 1,3-cyclohexane dicarboxylic acids, 1,2- or 1,3-phenyl enediacetic acids, 1,2- or 1,3-cyclohexane diacetic acids, isophthalic acid, terephthalic acid, 4,4′-oxybisbenzoic acid, 4,4-benzophenone dicarboxylic acid, 2,6-napthalene dicarboxylic acid, p-t-butyl isophthalic acid and 2,5-furandicarboxylic acid, and mixtures thereof. In some embodiments, the diamine may be selected from the group consisting of ethanol diamine, trimethylene diamine, putrescine, cadaverine, hexamethyelene diamine, 2-methyl pentamethylene diamine, heptamethylene diamine, 2-methyl hexamethylene diamine, 3-methyl hexamethylene diamine, 2,2-dimethyl pentamethylene diamine, octamethylene diamine, 2,5-dimethyl hexamethylene diamine, nonamethylene diamine, 2,2,4- and 2,4,4-trimethyl hexamethylene diamines, decamethylene diamine, 5-methylnonane diamine, isophorone diamine, undecamethylene diamine, dodecamethylene diamine, 2,2,7,7-tetramethyl octamethylene diamine, bis(p-aminocyclohexyl)methane, bis(aminomethyl)norbornane, C₂-C₁₆ aliphatic diamine optionally substituted with one or more C₁ to C₄ alkyl groups, aliphatic polyether diamines and furanic diamines, such as 2,5-bis(aminomethyl)furan, and mixtures thereof. In preferred embodiments, the diacid is adipic acid and the diamine is hexamethylene diamine which are polymerized to form PA6,6.

It should be understood that the concept of producing a polyamide from diamines and diacids also encompasses the concept of other suitable monomers, such as, aminoacids or lactams. Without limiting the scope, examples of aminoacids can include 6-aminohaxanoic acid, 7-aminoheptanoic acid, 11-aminoundecanoic acid, 12-aminododecanoic acid, or combinations thereof. Without limiting the scope of the disclosure, examples of lactams can include caprolactam, enantholactam, lauryllactam, or combinations thereof. Suitable feeds for the disclosed process can include mixtures of diamines, diacids, aminoacids and lactams.

In some cases, the polyamide composition is polymerized using a conventional melt polymerization process. In one aspect, the aqueous monomer solution is heated under controlled conditions of time, temperature, and pressure to evaporate water, effect polymerization of the monomers and provide a polymer melt.

In one embodiment, a nylon is prepared by a conventional melt polymerization of a nylon salt. Typically, the nylon salt solution is heated under pressure, e.g. 250 psig/1825×10³ n/m², to a temperature of, for example, about 245° C. Then the water vapor is exhausted off by reducing the pressure to atmospheric pressure while increasing the temperature to, for example, about 270° C. The resulting molten nylon is held at this temperature for a period of time to bring it to equilibrium prior to being extruded into a fiber. In some aspects, the process may be carried out in a batch or continuous process.

In some aspects, the fabric is melt blown. Melt blowing is advantageously less expensive than electrospinning. Melt blowing is a process type developed for the formation of microfibers and nonwoven webs. Until recently, microfibers have been produced by melt blowing. Now, nanofibers may also be formed by melt blowing. The nanofibers are formed by extruding a molten thermoplastic polymeric material, or polyamide, through a plurality of small holes, e.g., in a spinneret. Appropriate relative viscosity is required, see discussion above. The resulting molten threads or filaments pass into converging high velocity gas streams which attenuate or draw the filaments of molten polyamide to reduce their diameters. Thereafter, the melt blown nanofibers are carried by the high velocity gas stream and deposited on a collecting surface, or forming wire, to form a nonwoven web of randomly disbursed melt blown nanofibers. The formation of nanofibers and nonwoven webs by melt blowing is well known in the art. See, e.g., U.S. Pat. Nos. 3,704,198; 3,755,527; 3,849,241; 3,978,185; 4,100,324; and 4,663,220.

One option, “Island-in-the-sea,” refers to fibers forming by extruding at least two polymer components from one spinning die, also referred to as conjugate spinning.

As is well known, electrospinning has many fabrication parameters that may limit spinning certain materials. These parameters include: electrical charge of the spinning material and the spinning material solution; solution delivery (often a stream of material ejected from a syringe); charge at the jet; electrical discharge of the fibrous membrane at the collector; external forces from the electrical field on the spinning jet; density of expelled jet; and (high) voltage of the electrodes and geometry of the collector. In contrast, the aforementioned nanofibers and products are advantageously formed without the use of an applied electrical field as the primary expulsion force, as is required in an electrospinning process. Thus, the polyamide is not electrically charged, nor are any components of the spinning process. Importantly, the dangerous high voltage necessary in electrospinning processes, is not required with the presently disclosed processes/products. In some embodiments, the process is a non-electrospin process and resultant product is a non-electrospun product that is produced via a non-electrospin process.

Another embodiment of making the nanofiber nonwovens is by way of 2-phase spinning or melt blowing with propellant gas through a spinning channel as is described generally in U.S. Pat. No. 8,668,854. This process includes two phase flow of polymer or polymer solution and a pressurized propellant gas (typically air) to a thin, preferably converging channel. The channel is usually and preferably annular in configuration. It is believed that the polymer is sheared by gas flow within the thin, preferably converging channel, creating polymeric film layers on both sides of the channel. These polymeric film layers are further sheared into nanofibers by the propellant gas flow. Here again, a moving collector belt may be used and the basis weight of the nanofiber nonwoven is controlled by regulating the speed of the belt. The distance of the collector may also be used to control fineness of the nanofiber nonwoven.

Beneficially, the use of the aforementioned polyamide precursor in the melt spinning process provides for significant benefits in production rate, e.g., at least 5% greater, at least 10% greater, at least 20% greater, at least 30% greater, at least 40% greater. The improvements may be observed as an improvement in area per hour versus a conventional process, e.g., another process that does not employ the features described herein. In some cases, the production increase over a consistent period of time is improved. For example, over a given time period, e.g., one hour, of production, the disclosed process produces at least 5% more product than a conventional process or an electrospin process, e.g., at least 10% more, at least 20% more, at least 30% more, or at least 40% more.

Still yet another methodology which may be employed is melt blowing. Melt blowing involves extruding the polyamide into a relatively high velocity, typically hot, gas stream.

U.S. Pat. No. 7,300,272 (incorporated herein by reference) discloses a fiber extrusion pack for extruding molten material to form an array of nanofibers that includes a number of split distribution plates arranged in a stack such that each split distribution plate forms a layer within the fiber extrusion pack, and features on the split distribution plates form a distribution network that delivers the molten material to orifices in the fiber extrusion pack. Each of the split distribution plates includes a set of plate segments with a gap disposed between adjacent plate segments. Adjacent edges of the plate segments are shaped to form reservoirs along the gap, and sealing plugs are disposed in the reservoirs to prevent the molten material from leaking from the gaps. The sealing plugs can be formed by the molten material that leaks into the gap and collects and solidifies in the reservoirs or by placing a plugging material in the reservoirs at pack assembly. This pack can be used to make nanofibers with a melt blowing system described in the patents previously mentioned. The systems and method of U.S. Pat. No. 10,041,188 (incorporated herein by reference) are also exemplary.

If fibers are produced, a fabric can be made from the fibers by conventional means.

### Fiber/Fabric Characteristics

In some embodiments, the fabric comprises a plurality of fibers having an average fiber diameter less than 50 microns, e.g., less than 45 microns, less than 40 microns, less than 35 microns, less than 30 microns, less than 25 microns, less than 20 microns, less than 15 microns, less than 10 microns, or less than 5 microns. In terms of lower limits, the plurality of fibers may have an average fiber diameter greater than 1 micron, e.g., greater than 1.5 microns, greater than 2 microns, greater than 2.5 microns, greater than 5 microns, or greater than 10 microns. In terms of ranges, the plurality of fibers may have an average fiber diameter from 1 micron to 50 microns, e.g., from 1 micron to 45 microns, from 1 micron to 40 microns, from 1 micron to 35 microns, from 1 micron to 30 microns, from 1 micron to 20 microns, from 1 micron to 15 microns, from 1 micron to 10 microns, from 1 micron to 5 microns, from 1.5 microns to 25 microns, from 1.5 microns to 20 microns, from 1.5 microns to 15 microns, from 1.5 microns to 10 microns, from 1.5 microns to 5 microns, from 2 microns to 25 microns, from 2 microns to 20 microns, from 2 microns to 15 microns, from 2 microns to 10 microns, from 2 microns to 5 microns, from 2.5 microns to 25 microns, from 2.5 microns to 20 microns, from 2.5 microns to 15 microns, from 2.5 microns to 10 microns, from 2.5 microns to 5 microns, from 5 microns to 45 microns, from 5 microns to 40 microns, from 5 microns to 35 microns, from 5 microns to 30 microns, from 10 microns to 45 microns, from 10 microns to 40 microns, from 10 microns to 35 microns, from 10 microns to 30 microns. In some cases, fibers of this size may be referred to as microfibers.

In some embodiments, the fabric comprises a plurality of fibers having an average fiber diameter less than 1 micron, e.g., less than 0.9 microns, less than 0.8 microns, less than 0.7 microns, less than 0.6 microns, less than 0.5 microns, less than 0.4 microns, less than 0.3 microns, less than 0.2 microns, less than 0.1 microns, less than 0.05 microns, less than 0.04 microns, or less than 0.03 microns. In terms of lower limits, the average fiber diameter of the plurality of fibers may be greater than 1 nanometer, e.g., greater than 10 nanometers, greater than 25 nanometers, or greater than 50 nanometers. In terms of ranges, the average fiber diameter of the plurality of fibers may be from 1 nanometer to 1 micron, e.g., from 1 nanometer to 0.9 microns, from 1 nanometer to 0.8 microns, from 1 nanometer to 0.7 microns, from 1 nanometer to 0.6 microns, from 1 nanometer to 0.5 microns, from 1 nanometer to 0.4 microns, from 1 nanometer to 0.3 microns, from 1 nanometer to 0.2 microns, from 1 nanometer to 0.1 microns, from 1 nanometer to 0.05 microns, from 1 nanometer to 0.04 microns, from 1 nanometer to 0.3 microns, from 10 nanometers to 1 micron, from 10 nanometers to 0.9 microns, from 10 nanometers to 0.8 microns, from 10 nanometers to 0.7 microns, from 10 nanometers to 0.6 microns, from 10 nanometers to 0.5 microns, from 10 nanometers to 0.4 microns, from 10 nanometers to 0.3 microns, from 10 nanometers to 0.2 microns, from 10 nanometers to 0.1 microns, from 10 nanometers to 0.05 microns, from 10 nanometers to 0.04 microns, from 10 nanometers to 0.03 microns, from 25 nanometers to 1 micron, from 25 nanometers to 0.9 microns, from 25 nanometers to 0.8 microns, from 25 nanometers to 0.7 microns, from 25 nanometers to 0.6 microns, from 25 nanometers to 0.5 microns, from 25 nanometers to 0.4 microns, from 25 nanometers to 0.3 microns, from 25 nanometers to 0.2 microns, from 25 nanometers to 0.1 microns, from 25 nanometers to 0.05 microns, from 25 nanometers to 0.04 microns, from 25 nanometers to 0.03 microns, from 50 nanometers to 1 micron, from 50 nanometers to 0.9 microns, from 50 nanometers to 0.8 microns, from 50 nanometers to 0.7 microns, from 50 nanometers to 0.6 microns, from 50 nanometers to 0.5 microns, from 50 nanometers to 0.4 microns, from 50 nanometers to 0.3 microns, from 50 nanometers to 0.2 microns, or from 50 nanometers to 0.1 microns. In some cases, fibers of this size may be referred to as nanofibers.

In some cases, the fabric/layer has a thickness ranging from 0.05 mm to 10 mm, e.g., from 0.05 mm to 7 mm microns, from 0.1 mm to 2.0 mm, or from 0.3 mm to 1.0 mm, or from 0.4 mm to 0.8 mm. In terms of upper limits, the fabric/layer may have a thickness less than 10 mm, e.g., less than 8 mm, less than 7 mm, less than 5 mm, less than 3 mm, less than 2 mm, or less than 1 mm. In terms of lower limits, the fabric/layer may have a thickness greater than 0.05 mm, e.g., greater than 0.07 mm, greater than 0.1 mm, greater than 0.3 mm, greater than 0.4 mm, or greater than 0.5 mm.

It has been found that the fabric may advantageously be composed of a relatively hydrophilic and/or hygroscopic material. A polymer of increased hydrophilicity and/or hygroscopy may better attract and hold moisture and/or to manage moisture when worn. As discussed below, improved, e.g., increased, hydrophilicity and/or hygroscopy may be accomplished by utilizing the polymer compositions described herein. In some cases, the hydrophilicity and/or hygroscopy of the improved fibers/fabrics may be measured by saturation. In some cases, the hydrophilicity and/or hygroscopy of a given layer of the fibers/fabrics may be measured by the amount of water it can absorb (as a percentage of total weight). In some embodiments, the layer is capable of absorbing greater than 1.5 wt. % water, based on the total weight of the polymer, e.g., greater than 2.0 wt. %, greater than 3.0%, greater than 5.0 wt. %, greater than 7.0 wt. %, greater than 10.0 wt. %. or greater than 25.0 wt. %. In terms of ranges, the hydrophilic and/or hygroscopic polymer may be capable of absorbing water in an amount ranging from 1.5 wt. % to 50.0 wt. %, e.g., from 1.5 wt. % to 14.0 wt. %, from 1.5 wt. % to 9.0 wt. %, from 2.0 wt. % to 8 wt. %, from 2.0 wt. % to 7 w %, from 2.5 wt. % to 7 wt. %, or from 1.5 wt. % to 25.0 wt. %.

### Performance Characteristics

The performance of the fibers/fabrics described herein may be assessed using a variety of conventional metrics.

In some cases, the flame retardant fibers fibers/fabric demonstrate good performance when measured using ASTM D6413 (current year).

In some cases, the flame retardant fibers fibers/fabric demonstrate good performance when measured using ASTM F1930 (current year).

In some cases, the flame retardant fibers fibers/fabric demonstrate good performance when measured using ASTM F1959 (current year).

In some cases, the flame retardant fibers fibers/fabric demonstrate good performance when measured using ASTM F1506 (current year).

In some cases, the flame retardant fibers/fabric fibers demonstrate good performance when measured using NFPA 2112 (current year). To be compliant with NFPA 2112, the fabric should demonstrate no melting or dripping, and any afterflame should be less than 2 seconds, with a maximum char length of 4 inches.

In some cases, the flame retardant fibers fibers/fabric demonstrate good performance when measured using ASTM NFPA 70E (current year).

In some cases, the flame retardant fibers/fabrics demonstrate good washfastness performance, e.g., where a fabric is tested before and after 50 washes per ASTM 6413 and in both cases the fabric meets NFPA 2112.

In some cases, antiodor performance may be measured by toilet odor reduction, as measured in accordance with ISO 17299-3 (2014). In some embodiments, the AM/AV material demonstrates a toilet odor reduction greater than 50% e.g., greater than 60%, greater than 70%, greater than 80%, or greater than 90%. Toilet odor may be tested using specific test chemicals, e.g., ammonia, acetic acid, isovaleric acid, hydrogen sulfide, indole, and/or nonenal. At least one of the layers (or the fibers thereof) demonstrates the toilet odor reduction for one or more of these test chemicals.

In some cases, the protective fabric demonstrates a flame retardant index greater than 2, as measured in accordance with ISO 14116:2008, e.g., greater than 2.5, greater than 3.0, greater than 3.5, greater than 4.0, greater than 4.5, or greater than 5.0.

In some cases, the protective fabric demonstrates a (warp) tensile strength greater than 500N, as measured in accordance with BS EN ISO 13934-1:1999, e.g., greater than 600N, greater than 650N, greater than 700N, greater than 750N, greater than 800N, or greater than 900N.

In some cases, the protective fabric demonstrates a (weft) tensile strength greater than 200N, as measured in accordance with BS EN ISO 13934-1:1999, e.g., greater than 250N, greater than 300N, greater than 350N, greater than 360N, greater than 400N, or greater than 500N.

In some cases, the protective fabric demonstrates a (warp) tear strength greater than 25N, as measured in accordance with BS EN ISO 13937-3:2000, e.g., greater than 35N, greater than 40N, greater than 45N, greater than 50N, greater than 60N, or greater than 70N.

In some cases, the protective fabric demonstrates a (weft) tear strength greater than 25N, as measured in accordance with BS EN ISO 13937-3:2000, e.g., greater than 35N, greater than 40N, greater than 45N, greater than 50N, greater than 60N, or greater than 70N.

In some cases, the protective fabric demonstrates an abrasion resistance greater than 12,000 revs (at 9 KPa), as measured in accordance with BS EN ISO 12947-2:2016, e.g., greater than 13,000 revs, greater than 14,000 revs, greater than 15,000 revs, greater than 16,000 revs, greater than 17,000 revs, greater than 18,000 revs, or greater than 20,000 revs.

In some cases, the protective fabric demonstrates a water vapor resistance (Ret) greater than 4.00 m²Pa/W, as measured in accordance with ISO 11092:2014, e.g., greater than 4.25 m²Pa/W, greater than 4.5 m²Pa/W, greater than 4.66 m²Pa/W, greater than 4.70 m²Pa/W, greater than 4.75 m²Pa/W, or greater than 5.0 m²Pa/W.

In some cases, the protective fabric demonstrates a thermal resistance (Rct) greater than 0.01 m²K/W, as measured in accordance with ISO 11092:2014, e.g., greater than 0.03 m²K/W, greater than 0.05 m²K/W, greater than 0.07 m²K/W, greater than 0.10 m²K/W, greater than 0.12 m²K/W, or greater than 0.15 m²K/W.

In some cases, the protective fabric demonstrates an air permeability greater than 25.0 mm/sec, as measured in accordance with ISO 9237:2015, e.g., greater than 30.0 mm/sec, greater than 32.0 mm/sec, greater than 34.3 mm/sec, greater than 36.0 mm/sec, greater than 40.0 mm/sec, or greater than 45 mm/sec.

The strength of a polymer composition can also be characterized in terms of its elongation properties. It can be beneficial for polymeric materials to have high elongation because products manufactured from these materials are often subjected to stretching forces that can cause a material with low elongation to tear or rupture. Elongation can be measured with, for example, the standard test method ASTM D882-18 (2018) or ISO 527-2 (2012).

The tensile modulus of a polymer composition is a measure of the resistance of the composition to stretching forces. It can be beneficial for polymeric compositions to have low tensile moduli, because a lower modulus can increase the elasticity of products manufactured from the compositions and render these products more amenable to processing steps that involve stretching or thermoforming. Tensile moduli can be measured with, for example, the standard test method ASTM D882-18 (2018) or ISO 527-2 (2012).

As used herein, “greater than” and “less than” limits may also include the number associated therewith. Stated another way, “greater than” and “less than” may be interpreted as “greater than or equal to” and “less than or equal to.” It is contemplated that this language may be subsequently modified in the claims to include “or equal to.” For example, “greater than 4.0” may be interpreted as, and subsequently modified in the claims as “greater than or equal to 4.0.”

In some embodiments, any or some of the components or steps disclosed herein may be considered optional. In some cases, the disclosed compositions may expressly exclude any or some of the aforementioned components or steps in this description, e.g., via claim language. For example, claim language may be modified to recite that the disclosed compositions, materials processes, etc., do not utilize or comprise one or more of the aforementioned additives, e.g., the disclosed materials do not comprise a flame retardant or a delusterant. As another example, the claim language may be modified to recite that the disclosed materials do not comprise long chain polyamide component, e.g., PA-12. Such negative limitations are contemplated, and this text serves as support for negative limitations for components, steps, and/or features.

### EMBODIMENTS

As used below, any reference to a series of embodiments is to be understood as a reference to each of those embodiments disjunctively (e.g., “Embodiments 1-4” is to be understood as “Embodiments 1, 2, 3, or 4”).
Embodiment 1 is a process for making flame retardant fibers comprising: combining with a polymer a flame retardant masterbatch comprising a nitrogen compound having a melting point less than 400° C.; and a masterbatch polymer to form a polymer composition, and forming the flame retardant fibers from the polymer composition, wherein the flame retardant fibers pass the flame retardancy standards of ASTM D6413 (current year).
Embodiment 2 is an embodiment of embodiment 1, wherein the flame retardant masterbatch comprises greater than 10 wt % polymer, based on the total weight of the masterbatch.
Embodiment 3 is an embodiment of embodiment 1 or 2, wherein the polymer composition further comprises an AM/AV compound and wherein the flame retardant fibers demonstrate antiodor performance.
Embodiment 4 is an embodiment of any of embodiments 1-3, wherein the forming comprises forming multicomponent fibers and wherein the fibers demonstrate antistatic performance.
Embodiment 5 is an embodiment of any of embodiments 1-4, wherein the flame retardant masterbatch comprises less than 90 wt % nitrogen compound, based on the total weight of the masterbatch.
Embodiment 6 is an embodiment of any of embodiments 1-5, wherein the nitrogen compound comprises melamine or a melamine-based compound.
Embodiment 7 is an embodiment of any of embodiments 1-6, wherein the polymer comprises polyamide.
Embodiment 8 is an embodiment of any of embodiments 1-7, wherein the flame retardant fibers have an average fiber diameter less than 25 microns.
Embodiment 9 is an embodiment of any of embodiments 1-8, wherein the polymer composition has an RV less than 90 as measured via the formic acid method.
Embodiment 10 is an embodiment of any of embodiments 1-9, wherein the forming comprises forming first fibers comprising a first polymer and a first flame retardant masterbatch and combining the first fibers with second fibers.
Embodiment 11 is an embodiment of any of embodiments 1-10, wherein the forming comprises forming first fibers comprising a first polymer and a first flame retardant masterbatch and combining the first fibers with second fibers comprising cotton.
Embodiment 12 is an embodiment of any of embodiments 1-11, wherein the forming comprises forming first fibers comprising polyamide and combining the first fibers with second fibers comprising cotton.
Embodiment 13 is a garment or uniform having antiodor properties and flame retardancy properties comprising fibers made from an embodiment of any of embodiments 1-12.
Embodiment 14 is a garment or uniform having antistatic properties and flame retardancy properties comprising fibers made from an embodiment of any of embodiments 1-13.

We claim:

1. A process for making flame retardant fibers comprising:
combining with a polymer a flame retardant masterbatch comprising:
greater than 10 wt % of a nitrogen compound having a melting point less than 400° C.; and
a masterbatch polymer, with the weight percentages based on the total weight of the masterbatch, to form a polymer composition, and
forming the flame retardant fibers from the polymer composition,
wherein the flame retardant fibers pass the flame retardancy standards of ASTM D6413 (current year).

2. The process of claim 1, wherein the flame retardant masterbatch comprises greater than 10 wt % masterbatchpolymer, based on the total weight of the masterbatch.

3. The process of claim 1, wherein the flame retardant masterbatch comprises greater than 50 wt % of the nitrogen compound having a melting point less than 400° C.

4. The process of claim 1, wherein the polymer composition further comprises an AM/AV compound and wherein the flame retardant fibers demonstrate a toilet odor reduction greater than 50%.

5. The process of claim 1, wherein the AM/AV compound comprises a zinc compound, a copper compound, or a combination thereof.

6. The process of claim 1, wherein the flame retardant masterbatch comprises less than 90 wt % nitrogen compound, based on the total weight of the masterbatch.

7. The process of claim 1, wherein the nitrogen compound comprises melamine or a melamine-based compound.

8. The process of claim 1, wherein the nitrogen compound comprises triazine and/or triazine derivatives.

9. The process of claim 1, wherein the nitrogen compound comprises particles having an average particle diameter of less than 2 microns.

10. The process of claim 1, wherein the polymer comprises polyamide.

11. The process of claim 1, wherein the polymer comprises PA6, PA66, or a combination thereof.

12. The process of claim 1, wherein the masterbatch polymer comprises PA6, PA66, or a combination thereof.

13. The process of claim 1, wherein the flame retardant fibers have an average fiber diameter less than 25 microns.

14. The process of claim 1, wherein the polymer composition has an RV less than 90 as measured via the formic acid method.

15. The process of claim 1, wherein the forming comprises forming multicomponent fibers and wherein the fibers demonstrate antistatic performance.

16. The process of claim 1, wherein the forming comprises forming first fibers comprising a first polymer and a first flame retardant masterbatch and combining the first fibers with second fibers.

17. The process of claim 1, wherein the forming comprises forming first fibers comprising a first polymer and a first flame retardant masterbatch and combining the first fibers with second fibers comprising cotton.

18. The process of claim 17, wherein the first polymer comprises polyamide.

19. A garment or uniform having antiodor properties and flame retardancy properties comprising fibers made from the process of claim 1.

20. A garment or uniform having antistatic properties and flame retardancy properties comprising fibers made from the process of claim 1.
